(19) United States
(12) Patent Application Publication
(10) Pub. No.: US 2011/0246867 A1
(43) Pub. Date: Oct. 6, 2011

(54) FORM CREATION APPARATUS, CONTROL METHOD OF FORM CREATION APPARATUS, DATA PROCESSING APPARATUS, CONTROL METHOD OF DATA PROCESSING APPARATUS, AND STORAGE MEDIUM

(75) Inventor: Kensuke Tsutsumi, Kawasaki-shi (JP)

(73) Assignee: CANON KABUSHIKI KAISHA, Tokyo (JP)

(21) Appl. No.: 13/072,030

(22) Filed: Mar. 25, 2011

(30) Foreign Application Priority Data
Mar. 31, 2010 (JP) 2010-082801

(51) Int. Cl. G06F 17/00

(52) U.S. Cl. 715/222

(57) ABSTRACT

A form creation apparatus to communicate with a data management service that manages data to be overlaid on a form template may include a management unit, an acquisition unit, an overlaying unit, and a notification unit. The management unit manages the form template. The acquisition unit acquires the data from the data management service. The overlaying unit overlays on the form template, data acquired by the acquisition unit or data changed based on data acquired by the acquisition unit. The notification unit notifies, if data overlaid on the form template is the data changed based on the data acquired by the acquisition unit, that the data has been changed.

### BACKGROUND OF THE INVENTION

1. Field of the Invention

The present invention relates to a form creation apparatus capable of communicating with a data management service that manages data, a control method of the form creation apparatus, a data processing apparatus, a control method of a data processing apparatus, and a recording medium.

2. Description of the Related Art

In recent years, the cloud service, in which virtual machines can be built on a network, has started to become widely used as a result of an increase in network speed due to an improvement in network infrastructure, and a progress in grid computing technology. Such a spread of the cloud service has led to realization of a configuration that provides “software as a service” (SaaS) using the virtual machines on the cloud service.

It has also become important in a form creation service to collaborate with other services. The form creation service is a service that creates a form by compounding (overlaying) form data on a form template. An example of collaboration between the form creation service and other services is a service in which the form creation service acquires the data stored in the other service and overlays the acquired data as the form data on the form template.

When an information processing apparatus is to perform overlay of the form data, a user may change the form data to be overlaid on the form template. Japanese Patent Application Laid-Open No. 2001-005887 discusses a technique in which the information processing apparatus saves change history of the form data in such a case. According to the technique discussed in Japanese Patent Application Laid-Open No. 2001-005887, the user can understand the history of activities by the saved change history and can acquire details about the change.

In other words, when the data management service which stores and manages data collaborates with the form creation service that performs overlay, the user may desire to temporarily change the data that the form creation service acquires from the data management service just before performing overlay. However, if the form creation service temporarily changes the data and creates the form, the change in the data is not reflected in the data management service. The user using the data management service is thus unable to recognize whether the form created by the form creation service uses the original data or the changed data.

The method discussed in Japanese Patent Application Laid-Open No. 2001-005887 saves the contents of correction and the change associated with the form template on which the form data is to be overlaid, as history information. The user may thus understand the contents of correction and the change from history information. However, if the service that performs overlay is different from the service that manages the data, the temporary data change immediately before performing overlay is not reflected to the data management service, so that the user cannot recognize the data used in the created form.

### SUMMARY OF THE INVENTION

According to an aspect of the present invention, a form creation apparatus configured to communicate with a data management service that manages data to be overlaid on a form template includes a management unit configured to manage the form template, an acquisition unit configured to acquire the data from the data management service, an overlaying unit configured to overlay on the form template, data acquired by the acquisition unit or data changed based on data acquired by the acquisition unit, and a notification unit configured to notify, if data overlaid on the form template is the data changed based on the data acquired by the acquisition unit, that the data has been changed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a form system according to an exemplary embodiment.

FIG. 2 illustrates a hardware configuration of a computer according to the exemplary embodiment.

FIG. 3A illustrates a hardware configuration of a data management service according to an exemplary embodiment. FIG. 3B illustrates a software configuration of the data management service according to the exemplary embodiment.

FIG. 4A illustrates an example of record information stored in the data management service. FIG. 4B illustrates an example of history information stored in the data management service.

FIG. 5A illustrates a hardware configuration of a form creation service according to the exemplary embodiment. FIG. 5B illustrates a software configuration of the form creation service according to the exemplary embodiment.

FIG. 6A illustrates an example of request information stored in the form creation service. FIG. 6B illustrates an example of form correspondence information stored in the form creation service. FIG. 6C illustrates an example of a data acquisition query file stored in the form creation service.

FIG. 7A illustrates an example of a login screen created by the data management service. FIG. 7B illustrates an example of a sales negotiation screen created by the data management service.

FIG. 8A illustrates an example of a form selection screen created by the form creation service. FIG. 8B illustrates an example of a data confirmation screen created by the form creation service.

FIG. 9 is a flowchart illustrating a process for receiving a request performed by the form creation service.

FIG. 10 is a flowchart illustrating a process for receiving a data acquisition request performed by the form creation service.

FIG. 11 is a flowchart illustrating a process for receiving an overlay execution request performed by the form creation service.

FIG. 12 is a flowchart illustrating a form creation process performed by the form creation service.

### DESCRIPTION OF THE EMBODIMENTS

Various exemplary embodiments, features, and aspects of the invention will be described in detail below with reference to the drawings.

An embodiment is directed towards a form creation apparatus to communicate with a data management service that manages data to be overlaid on a form template. When a data, managed in a data management system having a form creation apparatus, is temporarily changed in an external system, the data management system is notified of the change in the data and the content of the change. As a result, a user can understand the data change in the external system on a screen of the data management system.

### <System Configuration>

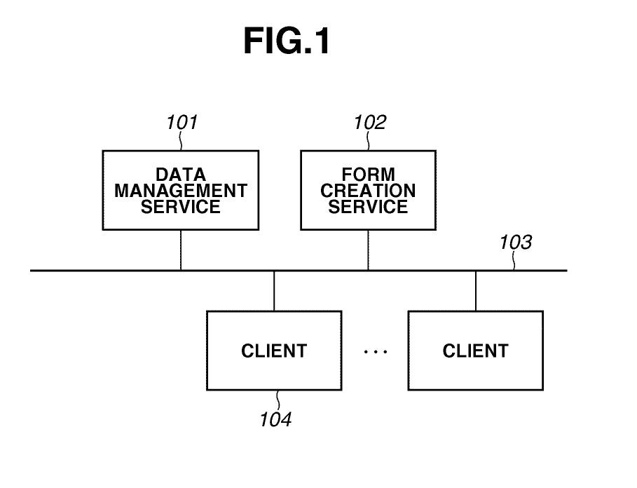

FIG. 1 is a block diagram illustrating a configuration of a form system according to an exemplary embodiment. Referring to FIG. 1, the form system includes a data management service 101, a form creation service 102, and a client 104 that are connected to be communicable with each other via a communication line 103.

The data management service 101 is a service that stores and manages data to be overlaid on a form template when creating the form, and provides to the clients 104 services such as confirming and editing the data via a web page. The form creation service 102 manages the form templates and creates the form desired by the client by acquiring data from the data management service 101 and performing overlay.

The client 104 is a computer that includes a web browser, and issues requests to the data management service 101 and the form creation service 102 via the web browser. The communication line 103 i.e., a communication network, is realized by a local area network (LAN) such as the Internet or an intranet, a wide area network (WAN), a telephone line, a dedicated digital line, an asynchronous transfer mode (ATM), or a frame relay line, a cable television line, a wireless data broadcast line, or a combination of such lines. The communication line 103 may be any line by which data can be transmitted or received. Further, a communication method between the client 104 and the data management service 101 or the form creation service 102 may be different from the communication method between the data management service 101 and the form creation service 102.

### <Client 104>

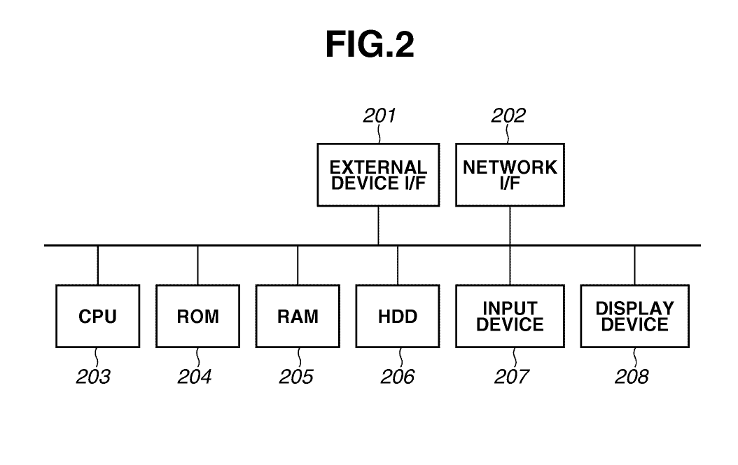

FIG. 2 is a block diagram illustrating a hardware configuration of a basic computer (i.e., an information processing apparatus) applied to the client 104.

Referring to FIG. 2, the computer includes an external device interface (I/F) 201, a network I/F 202, a central processing unit (CPU) 203, a read-only memory (ROM) 204, a random access memory (RAM) 205, a hard disk drive (HDD) 206, an input device 207, and a display device 208. These components are connected to each other via a system bus. Examples of the system bus are a protocol control information (PCI) bus, an accelerated graphic port (AGP) bus, and a memory bus. Connecting chips between each bus, and input/output interfaces between the components, such as a small computer system interface (SCSI) and an advanced technology attachment packet interface (ATAPI), are not illustrated in FIG. 2.

The CPU 203 reads the programs stored in the ROM 204 or the HDD 206 to the RAM 205 and executes processes based on such programs to control each of the processes performed on the computer. The ROM 204 stores the programs and data related to each of the processes performed on the computer. The RAM 205 electrically stores temporary data related to each of the processes performed on the computer. The HDD 206 stores the programs, data, and the temporary data related to each of the processes performed on the computer.

The input device 207 includes a keyboard and a pointing device that receives an instruction input to the computer by a user. The display device 208 displays an operation status of the computer or information output from each program executed on the computer. The network I/F 202 connects to the LAN and the Internet via a network and exchanges information with the outside. The external device I/F 201 connects to an external storage device.

The client 104 is a client computer that performs information processing. Each software module running on the client 104 is stored in the ROM 204 or the HDD 206. Each software module is loaded to the RAM 205 and executed by the CPU 203. Each of the clients 104 is connected to the communication line 103 via the network interface (not illustrated). The client 104 may be a computer that is connected to a persistent storage device, or may take a thin client configuration which includes only temporary storage devices.

The client 104 includes the web browser, so that the client 104 can issue a request to a web server using the web browser according to a user instruction, analyze a HyperText Markup Language (HTML) from the web browser, and display the result on a screen. The screen of the web browser is displayed on the display device 208 and the user can input an instruction using the input device 207.

### <Data Management Service 101>

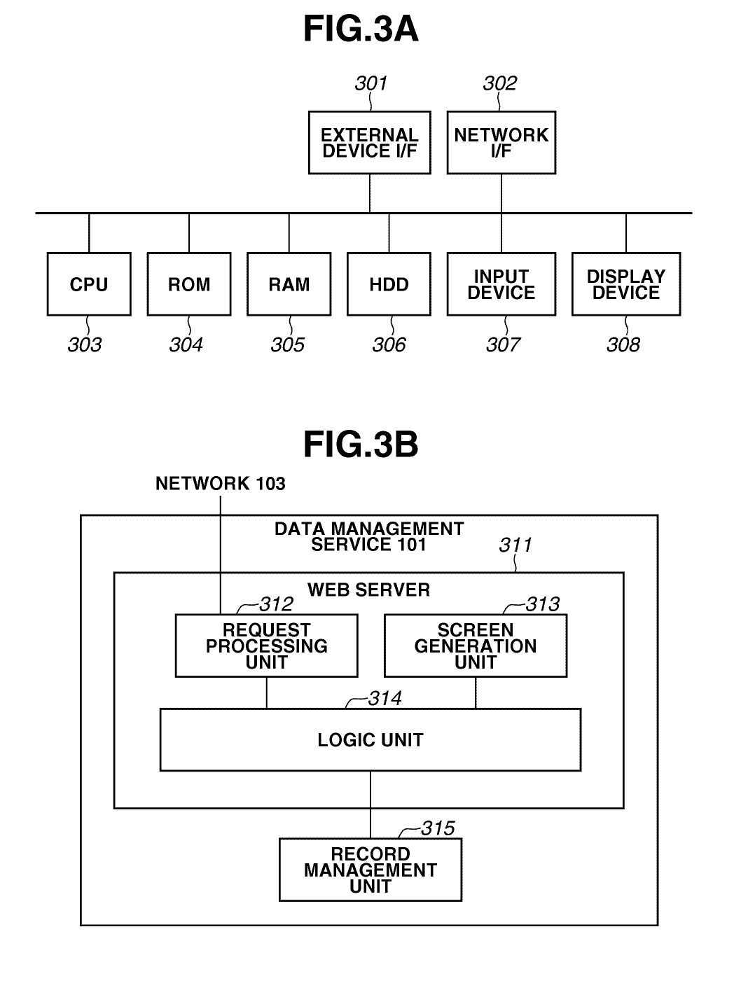

FIG. 3A is a block diagram illustrating a hardware configuration of a basic computer (data management apparatus and data management system) applied to the data management service. Configurations of an external device I/F 301, a network I/F 302, a CPU 303, a ROM 304, a RAM 305, a HDD 306, an input device 307, and a display device 308 are similar to those in the client 104 illustrated in FIG. 2. A detailed description on these components will thus be omitted.

FIG. 3B illustrates a software configuration of the data management service 101 according to the present exemplary embodiment. Each software module illustrated in FIG. 3B is stored in the HDD 306, and is loaded to the RAM 305 in the data management service 101 and executed by the CPU 303 in the data management service 101. Referring to FIG. 3B, the data management service 101 includes a web server 311 and a record management unit 315.

The web server 311 includes a request processing unit 312, a screen generation unit 313, and a logic unit 314. The request processing unit 312 receives a request from the client 104 and the form creation service 102 illustrated in FIG. 1 via the communication line 103. The request processing unit 312 then requests the logic unit 314 to generate a response to the received request, and returns the response generated by the logic unit 314 to the client 104 or the form creation service 102.

The request processing unit 312 returns, as the response to the request from the client 104, a web page to be displayed on the web browser by the display device 208 in the client 104, or information for redirecting (i.e., redirect information). The request processing unit 312 returns information in an extensible markup language (XML) format as the response to the request from the form creation service 102. Examples of the request received by the request processing unit 312 are a login request, a form creation request, a data acquisition request, a history notification request, and a file upload request.

The screen generation unit 313 manages images and screen information such as HTML or style that are necessary for generating the web page. The screen generation unit 313 acquires the screen information from the HDD 306 according to the instruction from the logic unit 314, and provides the screen information to the logic unit 314.

The logic unit 314 generates the response according to the request received by the request processing unit 312 and returns the response to the request processing unit 312. Types of response include the web page, the XML data, and the redirect information. When generating the web page as the response, the logic unit 314 inserts the record information and the history information stored in the record management unit 315 to the screen information generated by the screen generation unit 313.

Further, when generating the XML data as the response, the logic unit 314 acquires the record information from the record management unit 315, and forms the record information into the XML format. Furthermore, when generating the redirect information as the response, the logic unit 314 forms a redirect destination and parameter information to be transferred to the redirect destination, which are previously registered, into the format for redirecting in the client 104. A redirect method of the client 104 includes methods using a <meta> tag of the HTML and a Java Script. A process flow of the logic unit 314 will be described in detail below.

The record management unit 315 reads, writes, and manages the record information and the history information stored in the HDD 306. The record management unit 315 reads the information from the HDD 306 according to an information acquisition instruction from the logic unit 314 and returns the read information to the logic unit 314. The record management unit 315 updates the information stored in the HDD 306 according to an information update instruction from the logic unit 314.

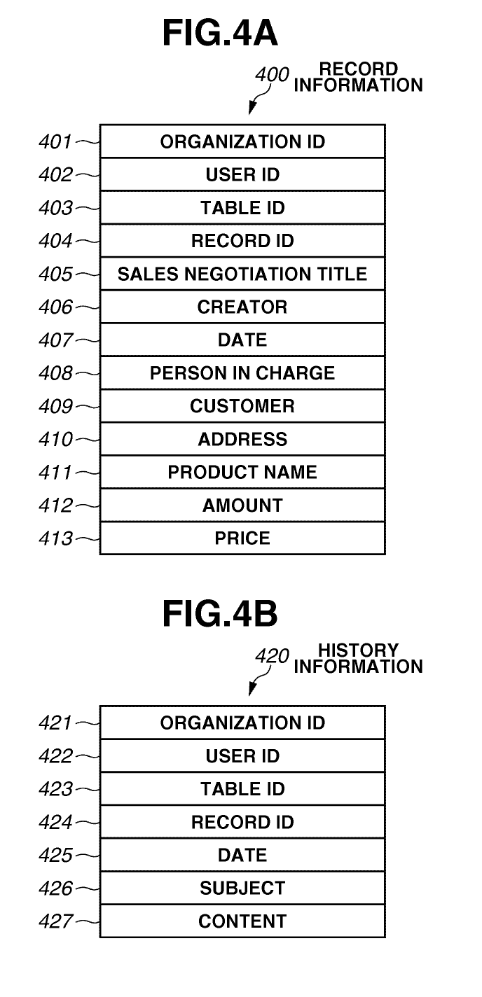

FIG. 4A illustrates an example of the record information managed by the record management unit 315 in the data management service 101. Referring to FIG. 4A, record information 400 includes an organization identification (ID) 401, a user ID 402, a table ID 403, a record ID 404, a sales negotiation title 405, a name of creator 406, a date 407, a name of person in charge 408, a name of customer 409, an address 410, a product name 411, an amount 412, and a price 413.

The organization ID 401, the user ID 402, the table ID 403, and the record ID 404 uniquely identify the organization, the user, the table, and the record respectively. The record management unit 315 can identify one of the record information 400 using such IDs. The user of the data management service 101 is stored as user information along with the user ID, and the user information is used in performing authentication when the data management service 101 receives the login request. The user information includes a user name, a password, and the user ID. A plurality of users may belong to the organization defined in the data management service 101, and the user may thus be managed as an organization (group). The organization ID 401 which is assigned to the defined organization is stored in the user information of the user who belongs to the organization.

In the form system illustrated in FIG. 1, the user authentication is performed by the data management service 101 that receives the login request from the client 104. The form creation service 102 can then take over the authentication of user accessing the data management service 101 by receiving a session ID as authenticated information. Further, a table can be defined for each process in the data management service 101 so that the table can be shared by the users in the organization.

The table includes processes such as sales negotiation, agreement, and report, and records are defined for each process. The user selects the defined table to perform the operation. According to the present exemplary embodiment, the sales negotiation is selected as an example of the table. Examples of the records defined in the sales negotiation table are the sales negotiation title 405, the name of creator 406, the date 407, the name of person in charge 408, the name of customer 409, the address 410, the product name 411, the amount 412, and the price 413.

FIG. 4B illustrates an example of the history information managed by the record management unit 315 in the data management service 101. Referring to FIG. 4B, history information 420 includes an organization ID 421, a user ID 422, a table ID 423, a record ID 424, a date 425, a subject 426, and a content 427. The organization ID 421, the user ID 422, the table ID 423, and the record ID 424 are IDs for uniquely identifying the organization, the user, the table, and the record respectively, similarly as in the record information 400. The history information 420 further includes the date 425 of when the history is registered, the subject 426 of the history, and the content 427 that is detailed information of the history.

### <Form Creation Service 102>

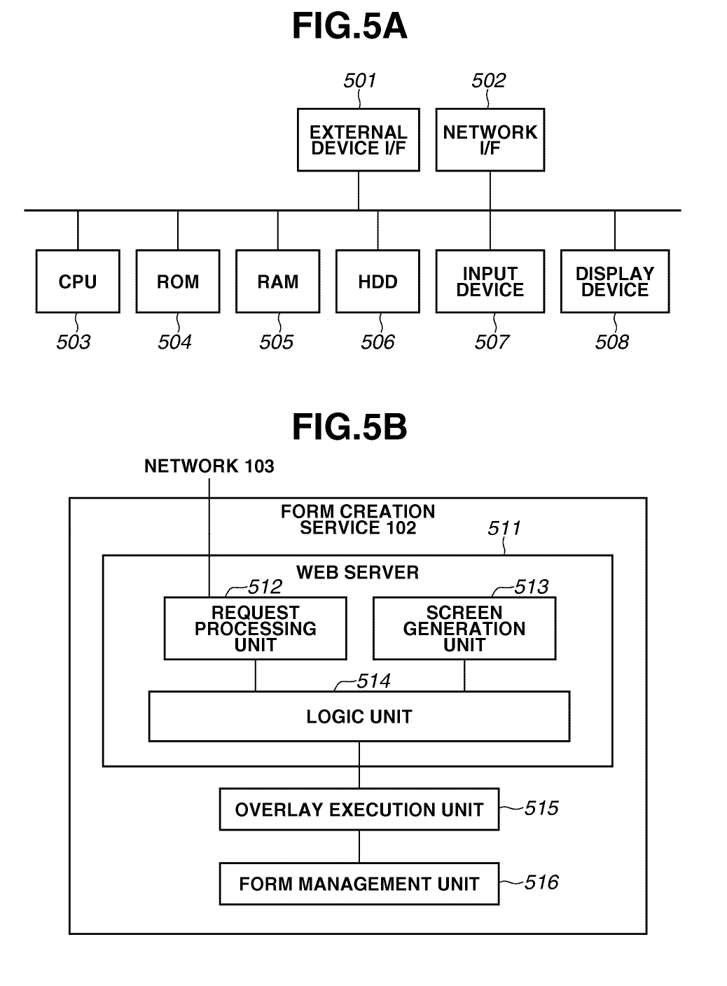

FIG. 5A is a block diagram illustrating a hardware configuration of the basic computer to be applied to the form creation service 102 (i.e., the form creation apparatus or the form creation system). Con figuration of an external device I/F 501, a network I/F 502, a CPU 503, a ROM 504, a RAM 505, a HDD 506, an input device 507, and a display device 508 are similar to those in the client 104 illustrated in FIG. 2. A detailed description on these components will thus be omitted.

FIG. 5B illustrates a software configuration of the form creation service 102 according to the present exemplary embodiment. Each software module illustrated in FIG. 5B is stored in the HDD 506 illustrated in FIG. 5A, and are loaded to the RAM 505 in the data management service 101 and executed by the CPU 503 in the form creation service 102 as described above. Referring to FIG. 5B, the form creation service 102 includes a web server 511, an overlay execution unit 515, and a form management unit 516.

The web server 511 includes a request processing unit 512, a screen generation unit 513, and a logic unit 514. Since the function of the screen generation unit 513 is similar to that of the screen generation unit 313 in the data management service 101 described above, description thereof will be omitted. The screen generation unit 513 and the logic unit 514 will be described below.

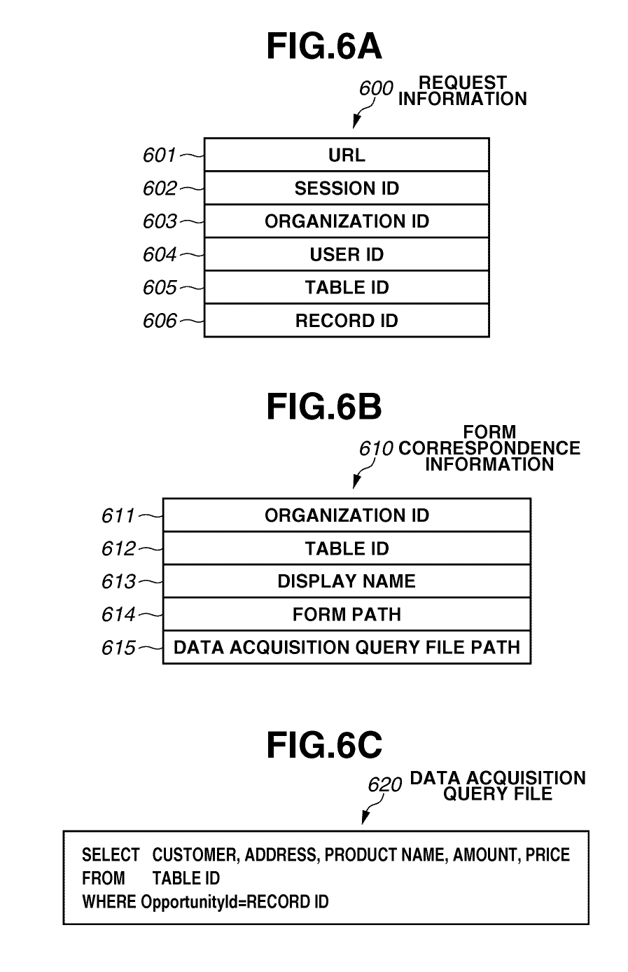

The request processing unit 512 receives from the client 104 the form creation request, a form selection request, and an overlay execution request. The request processing unit 512 then returns the web page or a preview file as the response to the client 104. Further, the request processing unit 512 issues the data acquisition request, the history notification request, and the file upload request to the data management service 101. According to the present exemplary embodiment, the information received by the request processing unit 512 from the client 104 in the form creation request will be described as request information. The request information will be described in detail below with reference to FIG. 6A.

The logic unit 514 generates the response according to the request received by the request processing unit 512, and transmits the response to the request processing unit 512. Further, the logic unit 514 requests the request processing unit 512 to issue the data acquisition request, the history notification request, and the file upload request. The logic unit 514 instructs the overlay execution unit 515 to perform overlay using the data acquired by issuing the data acquisition request to the data management service 101. The logic unit 514 then receives an overlay execution result. The flow of the process performed by the logic unit 514 will be described in detail below.

Upon receiving the overlay execution instruction from the logic unit 514, the overlay execution unit 515 acquires the form template from the form management unit 516, and overlays on the acquired form template the data received when the overlay execution instruction has been issued. The overlay execution unit 515 then returns to the logic unit 514 the form data created by performing overlay. Further, the overlay execution unit 515 stores form correspondence information that will be described in detail below with reference to FIG. 6B.

The form management unit 516 manages registration and acquisition of the form template. The form template managed by the form management unit 516 includes a fixed region such as fixed character strings and an image that are not changed by performing overlay, and a variable region to which data is input when performing overlay. The overlay execution unit 515 thus performs overlay and creates the form data by inputting the data in the variable region of the form template. Since a general method is employed in processing of the form template and overlay, description thereof will be omitted.

FIG. 6A illustrates an example of the request information that the request processing unit 512 receives from the client 104 along with the form execution request. Referring to FIG. 6A, request information 600 may be received as a parameter of a uniform resource locator (URL) or data in an HTML file, and the request may be in any format. The request information 600 includes a URL 601, a session ID 602, an organization ID 603, a user ID 604, a table ID 605, and a record ID 606.

The request information 600 is used when the form creation service 102 issues the data acquisition request to the data management service 101, and the URL 601 is a request address of the data acquisition request. The session ID 602 is issued by the data management service 101, and authentication is performed by adding the session ID to the data acquisition request. The organization ID 603, the user ID 604, the table ID 605, and the record ID 606 are similar to those in the above described record information 400 illustrated in FIG. 4A, and are information for uniquely identifying the record.

FIG. 6B illustrates form correspondence information 610 for associating the table in the data management service 101 and a query file executed when the data acquisition request is issued to the data management service 101 with the form template. The form correspondence information 610 includes an organization ID 611, a table ID 612, a display name 613, a form path 614, and a data acquisition query file path 615.

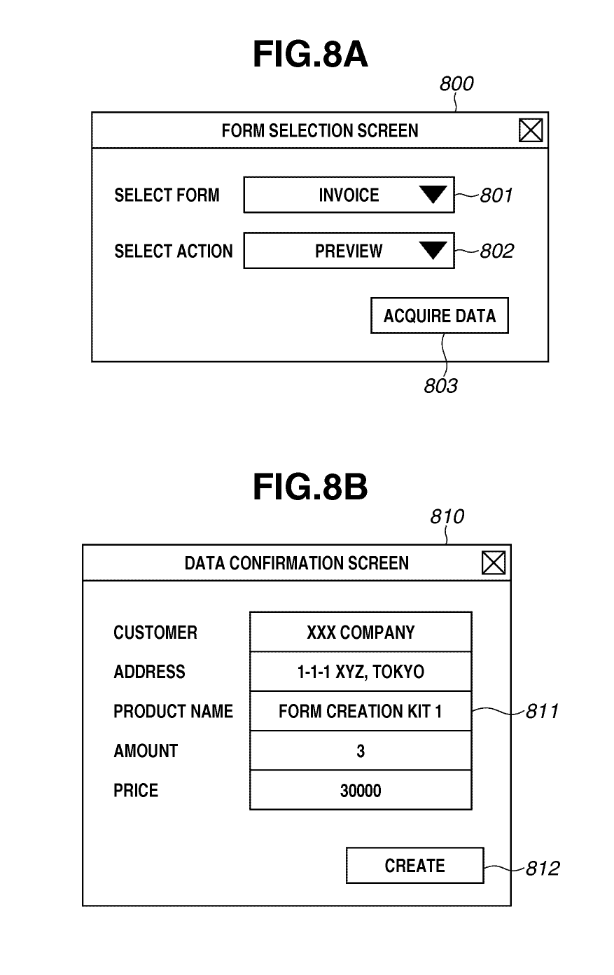

The organization ID 611 and the table ID 612 are similar to those in the above described record information 400, and are information for uniquely identifying the table. The display name 613 is the display name of the form template displayed on a form selection screen, which will be described below with reference to FIG. 8. The form path 614 is a file path in which the form template is stored. The data acquisition query file path 615 is a file path of the query file that is executed when the data acquisition request is issued to the data management service 101.

FIG. 6C illustrates an example of a data acquisition query file. Referring to FIG. 6C, a data acquisition query file 620 includes a FROM phrase, a WHERE phrase, and a SELECT phrase. The table and the record to be acquired are each designated in the FROM phrase and the WHERE phrase. An item to be acquired (i.e., an acquisition key) is designated is the SELECT phrase. When the overlay is performed, the data is overlaid in the variable region of the form template in the order described in the SELECT phase.

### <Screen of the Data Management Service 101>

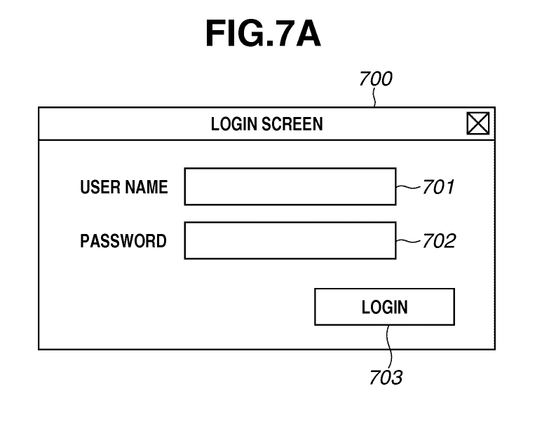

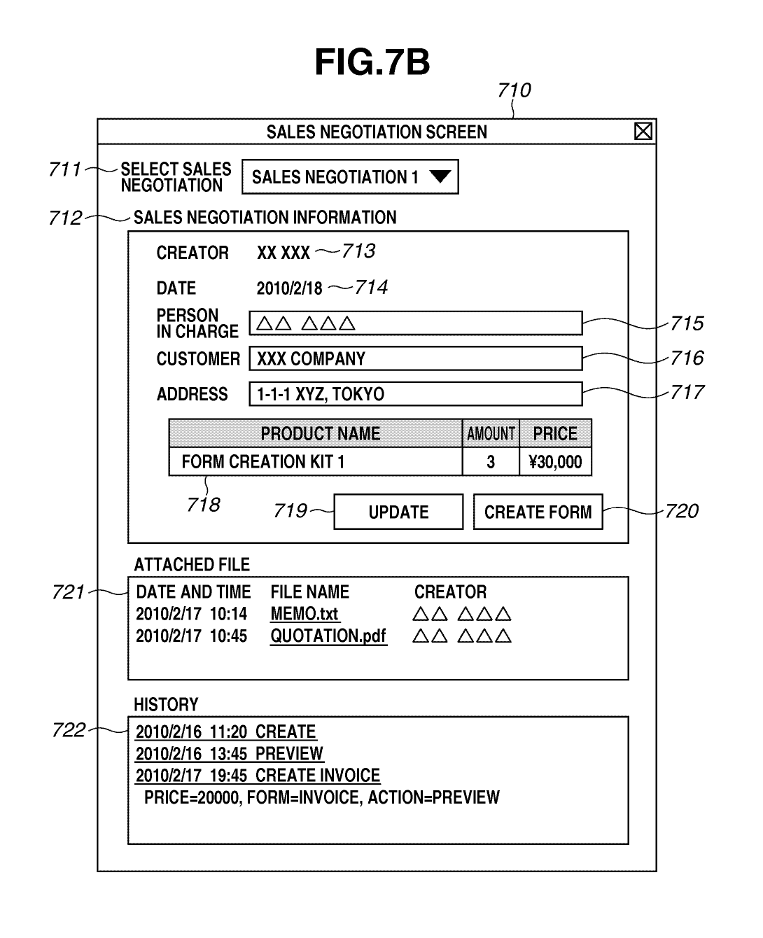

FIG. 7A illustrates an example of a login screen which is generated by the data management service 101 and displayed as the web browser screen on the display device 208 of the client 104. Referring to FIG. 7A, a login screen 700 is a screen displayed when the user initially accesses the data management service 101. The user inputs a user name and a password to a user name text box 701 and a password text box 702 respectively, and then presses a login button 703. The login request is then issued to the data management service 101 by the input user name and password. Upon receiving the login request, the data management service 101 performs authentication. If the authentication is successful, the data management service 101 returns a sales negotiation screen 710 illustrated in FIG. 7B as a response. On the other hand, if the authentication is unsuccessful, the login screen 700 is again displayed along with a login failure message.

FIG. 7B illustrates an example of the sales negotiation screen which is returned as a response after the login request is issued to the data management service 101. Referring to FIG. 7B, the sales negotiation screen 710 includes a “select sales negotiation” text box 711 and a sales negotiation information display area 712, an attached files display area 721, and a history display area 722. The user can select previously registered sales negotiation information using a pull-down menu on the “select sales negotiation” text box 711. The information about the sales negotiation selected using the pull-down menu is then displayed in the sales negotiation information display area 712, the attached files display area 721, and the history display area 722.

The information displayed in the sales negotiation information display area 712 includes a creator 713, a date 714, a person in charge 715, a customer 716, an address 717, and product information 718 of the sales negotiation. An update button 719 and a form creation button 720 are also included in the sales negotiation information display area 712. The displayed information is stored as the record information 400 illustrated in FIG. 4A. The person in charge 715, the customer 716, the address 717, and the product information 718 are in the form of text boxes in which values may be input by the user.

If the user presses the update button 719, the data management service 101 is notified of the input values in the text boxes, and the values are recorded in the record information 400. If the user presses the form creation button 720, the form creation request is issued to the data management service 101. The data management service 101 then returns the redirect of the form creation request to the form generation service 102 as a response. Upon receiving the form creation request, the form creation service 102 transmits as a response to the client 104 the form selection screen to be described below.

The attached files display area 721 displays the information about files uploaded to the data management service 101. The attached files display area 721 displays a date and time of uploading, a name of the uploaded file, and a user who uploaded the file. The user can download the uploaded file by clicking on the file name in the attached files display area 721.

The history display area 722 displays the history of the operations performed with respect to the record in the data management service 101. The history display area 722 displays the date 425, the subject 426, and the content 427 stored in the history information 420 illustrated in FIG. 4B.

### <Screen of the Form Creation Service 102>

FIG. 8A illustrates an example of the form selection screen which is generated by the form creation service 102 and displayed on the display device 208 of the client 104 as the web browser screen. Referring to FIG. 8A, a form selection screen 800 is a screen that is returned as a response when the form creation service 102 has received the form creation request. A “select form” box 801 is a pull-down text box in which the user can select the display name 613 of the form correspondence information 600 that matches the organization ID 603 and the table ID 605 in the request information 600 received along with the form creation request.

A “select action” box 802 is a pull-down text box for designating the operation to be executed after performing overlay. According to the present exemplary embodiment, “preview” and “attach” are items that can be selected in the “select action” box 802. “Preview” and “Attach” that are selected in the “select action” box 802 will be described in detail below. More specifically, “preview” is a method performed by the form creation service 102 for transmitting to the client 104 the form data created by performing overlay and displaying the form data on the display device 208 of the client 104. Further, “attach” is a method performed by the form creation service 102 for uploading the form data created by performing overlay to the data management service 101.

If the user presses a data acquisition button 803, the data acquisition request is issued to the form creation service 102 using the values selected on the “select form” box 801 and the “select action” box 802. When data acquisition is successful, a data confirmation screen 810 illustrated in FIG. 8B is returned as a response.

FIG. 8B illustrates an example of a data confirmation screen which is generated by the form creation service 102 and displayed as a web browser screen on the display device 208 of the client 104. Referring to FIG. 8B, the data acquired from the data management service 101 can be confirmed and changed using a text box 811 in the data confirmation screen 810.

If the user presses a “create” button 812, the overlay execution request is issued to the form creation service 102 using the changed values, or the values that has not been changed and only confirmed in the text boxes 811. The process performed by the form creation service 102 receiving the overlay execution request will be described in detail below. According to the present exemplary embodiment, the data associated with the overlay execution request will be referred to as variable data. The variable data includes values that are changed or values that have not been changed and only confirmed in the text boxes 811.

<A Process Performed by the Form Creation Service 102 when Receiving a Request>

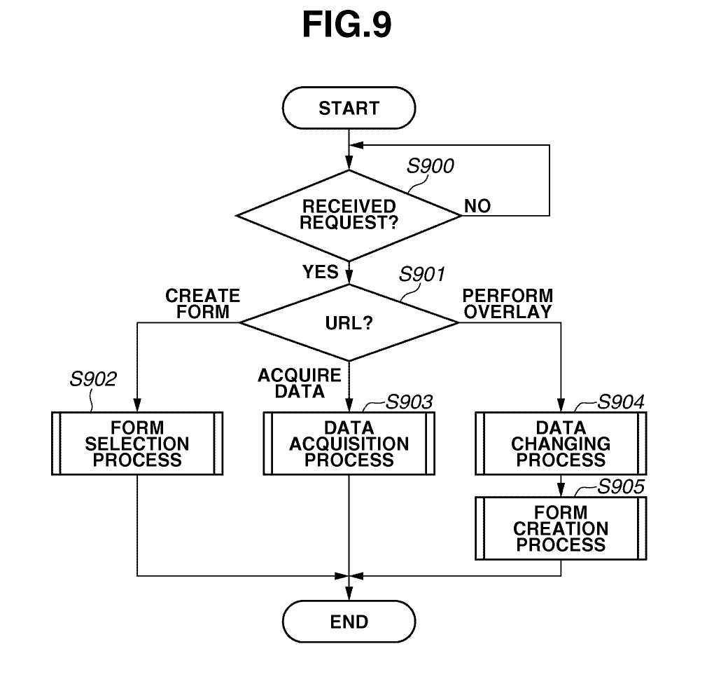

FIG. 9 is a flowchart illustrating a process performed by the form creation service 102 when receiving a request. Each of the processes in the flowchart illustrated in FIG. 9 is realized by the CPU 503 executing each of the software modules stored in the HDD 506.

In step S900, the request processing unit 512 determines whether a request has been received. If the request has been received (YES in step S900), the process proceeds to step S901. On the other hand, if the request has not been received (NO in step S900), the process waits for reception of the request in step S900.

In step S901, the request processing unit 512 confirms the URL of the received request and determines whether the request is the form creation request, the data acquisition request, or the overlay execution request. Since a different URL is defined for each of the request, the request processing unit 512 can determine the type of the request using the received URL.

If the received request is the form creation request (CREATE FORM in step S901), the process proceeds to step S902, i.e., a form selection process. If the received request is the data acquisition request (ACQUIRE DATA in step S901), the process proceeds to step S903, i.e., a data acquisition process. If the request is the overlay execution request (PERFORM OVERLAY in step S901), the process proceeds to step S904, i.e., a data changing process.

In step S902, the request processing unit 512 returns to the client 104 the created form selection screen 800 illustrated in FIG. 8A as the response. The form selection screen 800 is created as described above. In step S903, the data acquisition process which will be described in detail below is performed. In step S904, the data changing process is performed, and then in step S905, the form creation process is performed. The data changing process and the form creation process will be described in detail below. If an error occurs in the data changing process performed in step S904 (not illustrated), the form creation process in step S905 is not performed, and the process ends.

<A Process Performed by the Form Creation Service 102 when Receiving the Data Acquisition Request>

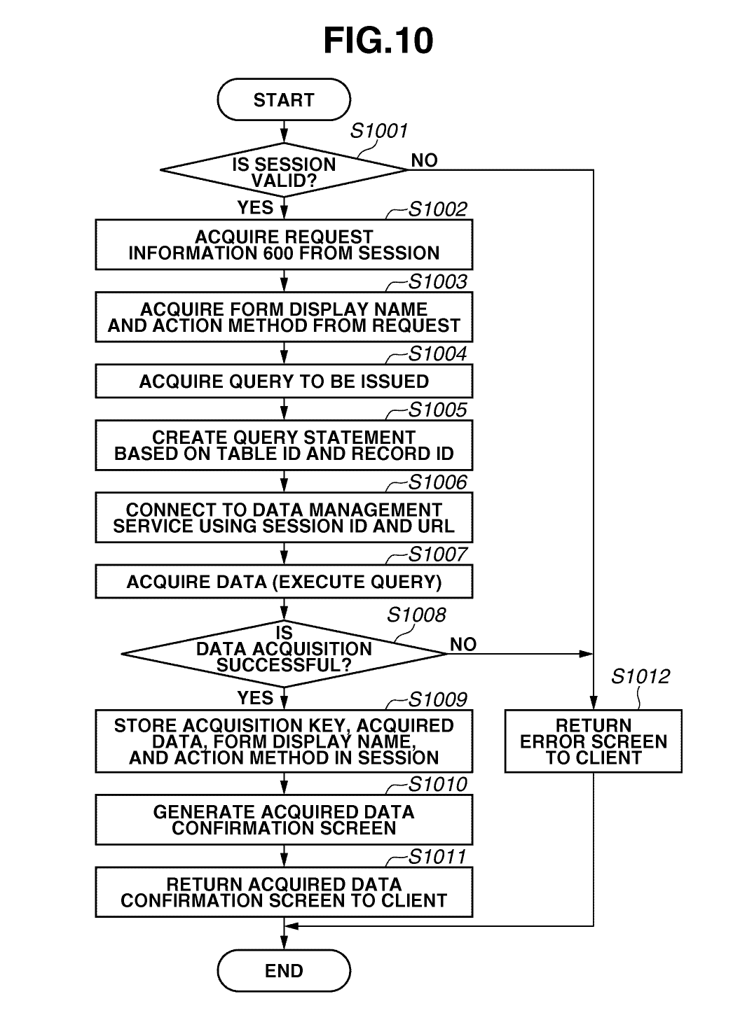

FIG. 10 is a flowchart illustrating in detail the data acquisition process in step S903 illustrated in FIG. 9 which is performed when the form generation service 102 receives the form creation request. Each of the processes in the flowchart illustrated in FIG. 10 is realized by the CPU 503 executing each of the software modules stored in the HDD 506.

In step S1001, the request processing unit 512 confirms whether the session is valid. The request processing unit 512 performs session management and stores as session information, the information for identifying the client 104 and the information requested by the client 104. If the request processing unit 512 confirms the validity of the session information and determines that the session information is invalid (NO in step S1001), the process proceeds to step S1012. On the other hand, if the session information is valid (YES in step S1001), the process proceeds to step S1002.

In step S1002, the logic unit 514 acquires from the session, the request information 600 received along with the form creation request. It is assumed that the form creation service 102 stores the request information 600 as the session information when receiving the form creation request. In step S1003, the logic unit 514 acquires the display name 613 and the action method selected in the “select form” box 801 and the “select action” box 802 in the form selection screen 800 illustrated in FIG. 8A. The action method received in the form selection screen 800 determines how the created form data is to be transmitted.

In step S1004, the logic unit 514 acquires the data acquisition query file 620 illustrated in FIG. 6C. More specifically, the logic unit 514 identifies the data acquisition query path 615 associated with the display name 613 acquired in step S1003 from the form correspondence information 610 managed in the form management unit 516. The logic unit 514 then acquires the data acquisition query file 620. In step S1005, the logic unit 514 inserts the table ID 605 and the record ID 606 included in the request information 600 to the data acquisition query file 620 acquired in step S1004, and creates a query statement.

In step S1006, the logic unit 514 connects to the URL 601 (i.e., the URL of the data management service 101) included in the request information 600 using the session ID 602 issued by the data management service 101 and included in the request information 600. After the connection to the data management service 101 is established, in step S1007, the logic unit 514 executes the data acquisition query file 620 created in step S1005 and acquires the data from the data management service 101.

In step S1008, the logic unit 514 determines whether the data is successfully acquired from the data management service 101. If the data acquisition is successful (YES in step S1008), the process proceeds to step S1009. If the data acquisition has failed (NO in step S1008), the process proceeds to step S1012. In step S1009, the logic unit 514 stores the acquisition key in the SELECT phrase in the data acquisition query file, the acquired data, the display name, and the action method as the session information of the same ID.

In step S1010, the logic unit 514 acquires the information about the acquired data confirmation screen from the screen generation unit 513, and creates the data confirmation screen 810 using the acquired data. In step S1011, the request processing unit 512 returns the data confirmation screen 810 created by the logic unit 514 as a response to the client 104.

In step S1012, the logic unit 514 acquires error screen information from the screen generation unit 513 and creates the error screen along with a message notifying of a session error. The request processing unit 512 then returns the created error screen to the client 104 as a response.

<A Process Performed by the Form Creation Service 102 when Receiving the Overlay Execution Request>

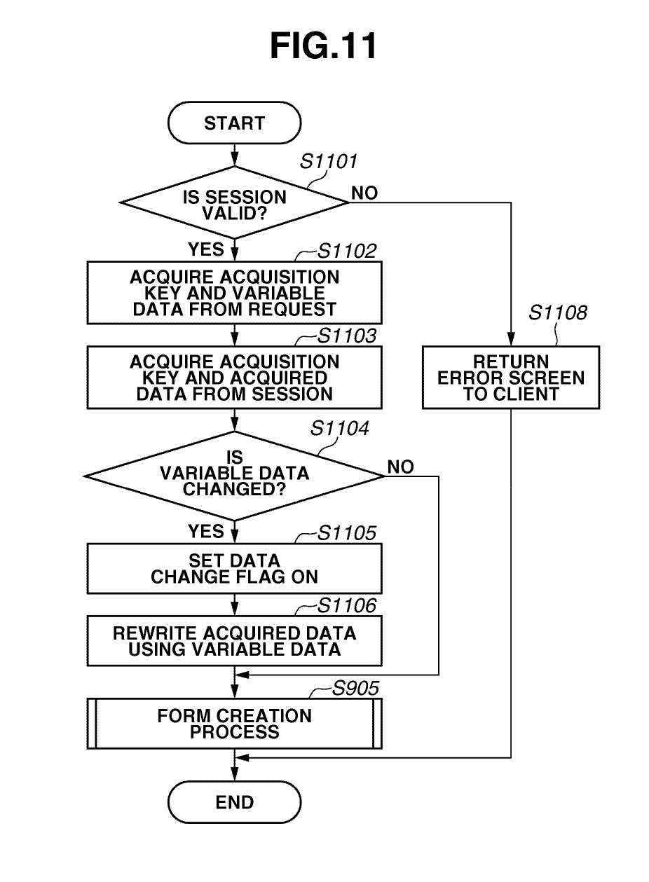

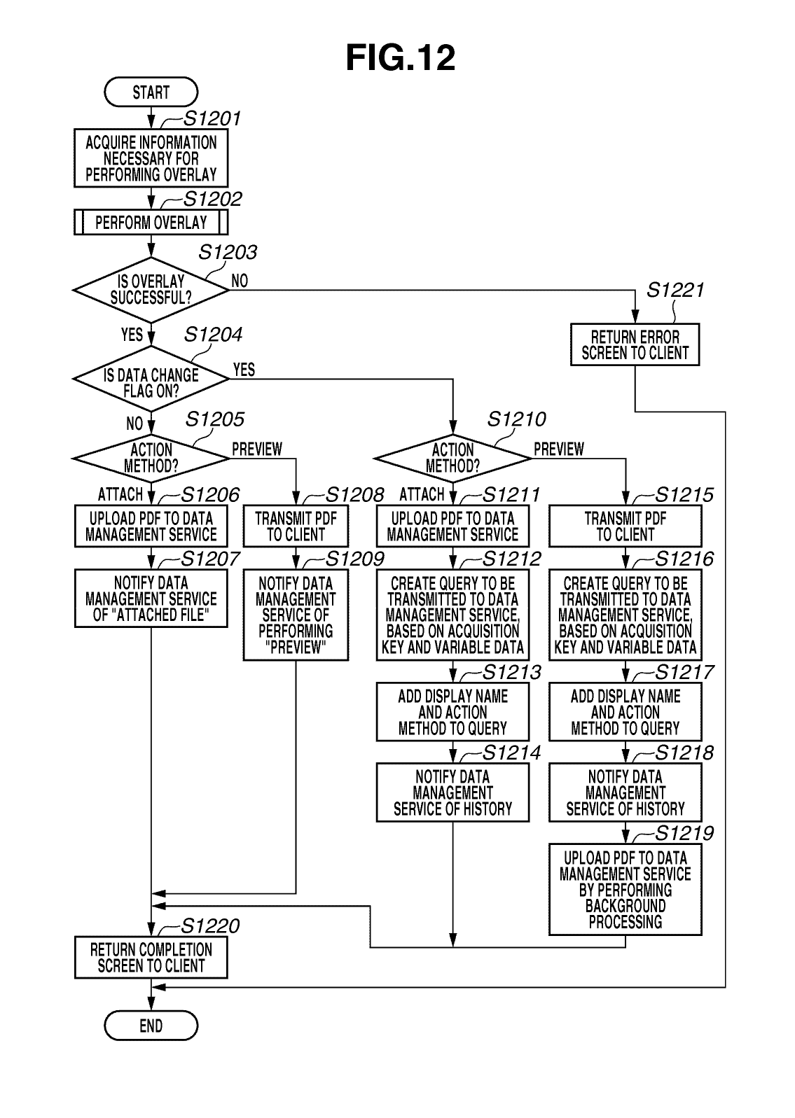

FIG. 11 is a flowchart illustrating in detail a process performed by the form creation service 102 when receiving the overlay execution request. Each of the processes in the flowchart illustrated in FIG. 11 is realized by the CPU 503 executing each of the software modules stored in the HDD 506. Further, the flowchart illustrated in FIG. 11 will particularly describe in detail the process performed in step S904 illustrated in FIG. 9, and the process performed in step S905 will be described below with reference to FIG. 12.

In step S1101, the request processing unit 512 determines whether the session is valid. If the request processing unit 512 determines that the session is valid (YES in step S1101), the process proceeds to step S1102. If the request processing unit 512 determines that the session is not valid (NO in step S1101), the process proceeds to step S1108. In step S1102, the logic unit 514 acquires from the overlay execution request, the variable data input to the text box 811 in the data confirmation screen 810 and the acquisition key in the SELECT phrase of the data acquisition query file 620 associated with the variable data.

In step S1103, the logic unit 514 acquires the acquisition key and the acquired data stored in the session in step S1009 illustrated in FIG. 10. In step S1104, the logic unit 514 determines whether the value of the variable data has been changed from the value of the acquired data. If the logic unit 514 determines that the value of the variable data has been changed (YES in step S1104), the process proceeds to step S1105. On the other hand, if the logic unit 514 determines that the value of the variable data has not been changed (NO in step S1104), the process proceeds to step S905.

The determination of whether the data has been changed in step S1104 is performed based on a comparison by the logic unit 514 between the acquired data that is acquired in step S1103 and the variable data acquired in step S1102. If the variable data has not been changed, the values of the acquired data and the variable data of the same acquisition key become the same.

In step S1105, the logic unit 514 sets a data change flag ON. In step S1106, the logic unit 514 rewrites the value of the acquired data corresponding to the changed acquisition key to the value of the variable data.

FIG. 12 is a flowchart illustrating in detail the form creation process (i.e., the process performed in step S905 illustrated in FIG. 9) performed by the form creation service 102 when receiving the overlay execution request. Each of the processes in the flowchart illustrated in FIG. 12 is realized by the CPU 503 executing each of the software modules stored in the HDD 506.

In step S1201, the overlay execution unit 515 receives an instruction to perform overlay from the logic unit 514 and acquires the information necessary for performing overlay. The information necessary for performing overlay includes the acquired data, the data change flag, the key that has been changed among the acquisition keys and the value of the changed key, the display name, and the action method.

In step S1202, the overlay execution unit 515 performs overlay using the information necessary for performing overlay. As described above, overlay is performed by the overlay execution unit 515 using the form template stored in the form management unit 516 and the data acquired by the data acquisition query file 620. According to the present exemplary embodiment, a portable document format (PDF) is created as a result of performing overlay.

In step S1203, the logic unit 514 determines whether the overlay execution unit 515 has succeeded in performing overlay and created the PDF. If the logic unit 514 determines that the overlay is successful (YES in step S1203), the process proceeds to step S1204. If the logic unit 514 determines that the overlay has failed (NO in step S1203), the process proceeds to step S1221.

In step S1204, the logic unit 514 confirms the data change flag and determines whether the created form data has been changed with respect to the data managed by the data management service 101. If the logic unit 514 determines that the data of the created form has been changed (i.e., the data change flag is ON) (YES in step S1204), the process proceeds to step S1210. On the other hand, if the logic unit 514 determines that the data of the created form has not been changed (i.e., the data change flag is OFF) (NO in step S1204), the process proceeds to step S1205.

In step S1205, the logic unit 514 determines whether the action method selected in the form selection screen 800 is “attach” or “preview”. If the logic unit 514 determines that “attach” has been selected (“ATTACH” in step S1205), the process proceeds to step S1206. If the logic unit 514 determines that “preview” has been selected (“PREVIEW” in step S1205), the process proceeds to step S1208.

In step S1206, upon receiving the request from the logic unit 514, the request processing unit 512 transmits and uploads the PDF, i.e., the form data created by the overlay execution unit 515, to the data management service 101. The uploaded form data is then stored in the data management service 101 and displayed on the attached files display area 721 in the sales negotiation screen 710 illustrated in FIG. 7B.

In step S1207, after completing uploading in step S1206, the request processing unit 512 notifies the data management service 101 of attachment of the form data as history in response to the request from the logic unit 514. The notified history is then stored as the history information 420 and displayed on the history display area 722 in the sales negotiation screen 710.

In step S1208, the request processing unit 512 transmits to the client 104 the PDF, i.e., the form data created by the overlay execution unit 515, in response to the request from the logic unit 514.

In step S1209, the request processing unit 512 notifies the data management service 101 of performing preview of the created form data (i.e., transmission of the created form data to the client 104) as history in response to the request from the logic unit 514. The data management service 101 stores the received history notification as the history information 420 and displays the history notification in the history display area 722 in the sales negotiation screen 710. A PDF reader is then activated on the client 104 that received the PDF in step S1208, and the PDF is displayed on the screen of the display device 208.

In step S1210, the logic unit 514 similarly determines the action method as in step S1205. If the logic unit 514 determines that “attach” has been selected (“ATTACH” in step S1210), the process proceeds to step S1211. If the logic unit 514 determines that “preview” has been selected (“PREVIEW” in step S1210), the process proceeds to step S1215.

In step S1211, the request processing unit 512 performs a similar process as in step S1206. In step S1212, the logic unit 514 adds the acquisition key and the variable data used in performing overlay to the query for the history notification to the data management service 101. According to this process, the data management service 101 can be notified of the information that has been changed immediately before performing overlay.

In step S1213, the logic unit 514 adds the display name and the action method acquired in step S1201 and used in performing overlay to the query for the history notification to the data management service 101. According to this process, the data management service 101 can thus be notified of the display name used in performing overlay and the action method after performing overlay.

In step S1214, the request processing unit 512 executes, in response to the request from the logic unit 514, the queries created in step S1212 and step S1213 and transmits the history notification to the data management service 101. The data management service 101 stores the received history notification as the history information 420 and displays the history notification in the history display area 722 in the sales negotiation screen 710.

The user can thus confirm the information about the change immediately before performing overlay that are added in step S1211 and step S1212, the display name used in performing overlay, and the action after performing overlay, which are displayed in the history display area 722.

In step S1215, the request processing unit 512 performs a similar process as in step S1208. In step S1216, the logic unit 514 performs a similar process as in step S1212. In step S1217, the logic unit 514 performs a similar process as in step S1213. In step S1218, the request processing unit 512 performs a similar process as in step S1214. As a result of performing the processes of step S1215 to step S1218, the PDF, i.e., the form data, is transmitted to the client, and the data management service 101 can be notified of the information about the change immediately before performing overlay for creating the form data.

In step S1219, the request processing unit 512 performs a similar process as in step S1206 in the background. The request processing unit 512 performs the process in step S1219 to store the overlay execution result in the data management service 101, when the data used in the created form is different from the data acquired from the data management service 101 even when performing preview. As a result of performing such a process, the form data is transmitted to both the data management service 101 and the client 104. The user can thus confirm the PDF in the history display area 722 in the sales negotiation screen 710 even after closing the previewed PDF.

In step S1220, the request processing unit 512 returns a completion screen indicating that the process has ended to the client 104 as a response to the request from the logic unit 514. A detailed description of the completion screen will be omitted. The request processing unit 512 acquires information about the completion screen from the screen generation unit 513, and returns the screen to which a message indicating the content of the completed process is added to the client 104 as a response.

In step S1221, the request processing unit 512 returns the error screen to the client 104 as a response to the request from the logic unit 514. The logic unit 514 creates the error screen by acquiring the screen information from the screen generation unit 513 and adding a detailed message about the error thereto.

As a result of performing the above described processes, if the user changes the data in the form creation service 102 when the data managed by the data management service 101 is to be overlaid on the form template included in the form creation service 102, the change can be confirmed in the data management service 101.

According to the above described exemplary embodiment, the hardware configurations of the data management service 101 and the form creation service 102 that are described as the information processing apparatuses, are illustrated in FIGS. 3 and 5. However, the present invention is not limited to such a configuration, and, for example, computer hardware sources such as the CPU, RAM, and HDD can be virtualized, and the software may be executed on a cloud platform that discloses a platform for running the software.

The software on the cloud platform is expanded in the RAM included in the cloud platform and executed by the CPU. However, since a large amount of computer resources is virtualized in the cloud platform, it is not necessary for the software to consider the computer resources operating in the background. A representative configuration of the cloud platform can register an operating system (OS) or a web application. According to the present exemplary embodiment, the cloud platform may be of any configuration. The software on the cloud platform may connect to the LAN and the Internet via the network I/F.

Embodiments can be also achieved by executing the following processing. More specifically, software (i.e., a program code) that can implement the functions of the above described exemplary embodiment is supplied to a system or an apparatus via a network or various storage media, and a computer (or CPU or micro processing unit (MPU)) of the system or the apparatus reads and executes the program. In such a case, the program code itself and a storage medium which stores the program code constitute an embodiment. In an example, a computer-readable medium may store a program that causes a form creation apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-082801 filed Mar. 31, 2010, which is hereby incorporated by reference herein in its entirety.

What is claimed is:

1. A form creation apparatus configured to communicate with a data management service that manages data to be overlaid on a form template, the form creation apparatus comprising:
a management unit configured to manage the form template;
an acquisition unit configured to acquire the data from the data management service;
an overlaying unit configured to overlay on the form template, data acquired by the acquisition unit or data changed based on data acquired by the acquisition unit; and
a notification unit configured to notify, if data overlaid on the form template is the data changed based on the data acquired by the acquisition unit, that the data has been changed.

2. The form creation apparatus according to claim 1, wherein the form creation apparatus is configured to communicate with an information processing apparatus including a display unit in addition to the data management service, the form creation apparatus further comprising:
a first transmission unit configured to transmit form data to the information processing apparatus to be displayed on the display unit;
a second transmission unit configured to transmit the form data to the data management service to be managed by the data management service;
a receiving unit configured to receive an instruction indicating whether the first transmission unit or the second transmission unit is to perform transmission; and
a determination unit configured to determine whether the first transmission unit or the second transmission unit is to perform transmission according to the instruction received by the receiving unit.

3. The form creation apparatus according to claim 2, wherein, if the receiving unit receives an instruction indicating that the first transmission unit will transmit the form data and the data overlaid on the form template is data that is changed based on the data acquired by the acquisition unit, the determination unit determines that transmission will be performed by both the first transmission unit and the second transmission unit.

4. The form creation apparatus according to claim 3, wherein, if both the first transmission unit and the second transmission unit are to perform transmission, the second transmission unit transmits the form data in background.

5. The form creation apparatus according to claim 1, wherein the notification unit notifies of changed contents of the data.

6. The form creation apparatus according to claim 1, wherein the notification unit notifies the data management service that the data has been changed.

7. A method for controlling a form creation apparatus configured to communicate with a data management service that manages data to be overlaid on a form template, the method comprising:
managing the form template;
acquiring the data from the data management service;
overlaying on the form template, the acquired data or data changed based on the acquired data; and
notifying, if data overlaid on the form template is the data changed based on the acquired data, that the data has been changed.

8. The method according to claim 7, wherein the form creation apparatus is configured to communicate with an information processing apparatus including a display unit in addition to the data management service, the method further comprising:
performing first transmission in which form data is transmitted to the information processing apparatus to be displayed on the display unit;
performing second transmission in which the form data is transmitted to the data management service to be managed by the data management service;
receiving an instruction indicating whether the first transmission or the second transmission is to be performed; and
determining whether the first transmission or the second transmission is to be performed according to the received instruction.

9. The method according to claim 8, further comprising: determining, if an instruction indicating that the form data is to be transmitted is received by the first transmission and the data overlaid on the form template is data that is changed based on the acquired data, that both the first transmission and the second transmission is to be performed.

10. The method according to claim 9, further comprising: transmitting, if transmission is performed by both the first transmission and the second transmission, the form data in background.

11. The method according to claim 7, further comprising:
notifying of changed contents of the data.

12. The method according to claim 7, further comprising: notifying the data management service that the data has been changed.

13. A computer-readable storage medium storing a program that causes a computer to perform a method according to claim 7.

14. A data processing apparatus configured to communicate with a data management service that manages first data, the data processing apparatus comprising:
a management unit configured to manage second data that is processed along with the first data managed by the data management service;
an acquisition unit configured to acquire the first data from the data management service;
a processing unit configured to process the first data acquired by the acquisition unit or data changed based on the first data acquired by the acquisition unit, along with the second data managed by the management unit; and
a notification unit configured to notify, if data processed along with the second data is the data changed based on the first data acquired by the acquisition unit, that the data has been changed.

15. A method for controlling data processing apparatus configured to communicate with a data management service that manages first data, the method comprising:
acquiring the first data from the data management service;
processing the acquired first data or data changed based on the acquired first data, along with second data that is processed together with the managed first data; and
notifying, if data processed along with the second data is data changed based on the acquired first data, that the data has been changed.

16. A computer-readable storage medium storing a program that causes a computer to perform a method according to claim 15.
